(19) United States
(12) Patent Application Publication
(10) Pub. No.: US 2010/0144164 A1
(43) Pub. Date: Jun. 10, 2010

(54) POWER CORD ASSEMBLY

(75) Inventors: Ching-Shun Wang, Taipei County (TW); Ming-Chung Wang, Taipei County (TW)

Correspondence Address: Brinks Hofer Gilson & Lione/Ann Arbor, 524 South Main Street, Suite 200, Ann Arbor, MI, 48104, US

(73) Assignee: Advanced Connection Technology, Inc., Taipei County (TW)

(21) Appl. No.: 12/329,016

(22) Filed: Dec. 5, 2008

(51) Int. Cl. H01R 11/30

(52) U.S. Cl. 439/39

(57) ABSTRACT

A power cord assembly includes first and second cable units. The first cable unit includes a first cable having first and second ends, a device connector disposed on the first end of the first cable and adapted to be coupled to a power port of an electrical device, and a first connector disposed on the second end of the first cable. The second cable unit includes a second cable having first and second ends, a power plug disposed on the first end of the second cable and adapted to be coupled to a power outlet, and a second connector disposed on the second end of the second cable. The first and second connectors are coupled electrically, magnetically, and releasably to each other.

### BACKGROUND OF THE INVENTION

1. Field of the Invention

This invention relates to a power cord assembly, more particularly to a power cord assembly for an electronic device, e.g., a laptop computer.

2. Description of the Related Art

FIG. 1 shows a conventional power cord assembly 2 that may be used to connect a laptop computer 1 to a power outlet 3. The power cord assembly 2 includes a device connector 21, a power plug 22, and a cable 23. The device connector 21 includes a set of terminals 211, and a magnet section 212 releasably and magnetically attracted to an input port 11 of the laptop computer 1.

As described above, the device connector 21 utilizes magnetism for connection to the laptop computer 1. One advantage of this structure is that the device connector 21 may be easily connected to and disconnected from the input port 11 of the laptop computer 1. However, frequent connection and disconnection with the laptop computer leads to dust, animal hair, etc. being easily gathered on the device connector 21. This is believed to be the cause of extremely high temperatures being generated in the device connector 21. In extreme instances, such high temperatures may be sufficient to melt the device connector 21 and/or the portion of the cable 23 attached thereto. Since the device connector 21 is directly connected to the input port 11 of the laptop computer 1, in the event that such high temperatures are generated by the device connector 21, the laptop computer 1 may be damaged.

### SUMMARY OF THE INVENTION

The object of the present invention is to provide a power cord assembly capable of overcoming the above-mentioned drawbacks of the prior art.

According to the present invention, a power cord assembly includes first and second cable units. The first cable unit includes a first cable having first and second ends, a device connector disposed on the first end of the first cable and adapted to be coupled to a power port of an electrical device, and a first connector disposed on the second end of the first cable. The second cable unit includes a second cable having first and second ends, a power plug disposed on the first end of the second cable and adapted to be coupled to a power outlet, and a second connector disposed on the second end of the second cable. The first and second connectors are coupled electrically, magnetically, and releasably to each other.

### BRIEF DESCRIPTION OF THE DRAWINGS

Other features and advantages of the present invention will become apparent in the following detailed description of the preferred embodiment with reference to the accompanying drawings, of which:

FIG. 1 is a perspective view of a conventional power cord assembly that is used for connecting a laptop computer to a power outlet;

FIG. 2 is a perspective view of the preferred embodiment of a power cord assembly according to the present invention;

FIG. 3 is a schematic side view of a first connector of the power cord assembly according to the present invention;

FIG. 4 is a schematic top view of the preferred embodiment to illustrate the first connector coupled to a second connector; and

FIG. 5 is a perspective view which is used to describe how the preferred embodiment of the power cord assembly may connect a laptop computer to a power outlet.

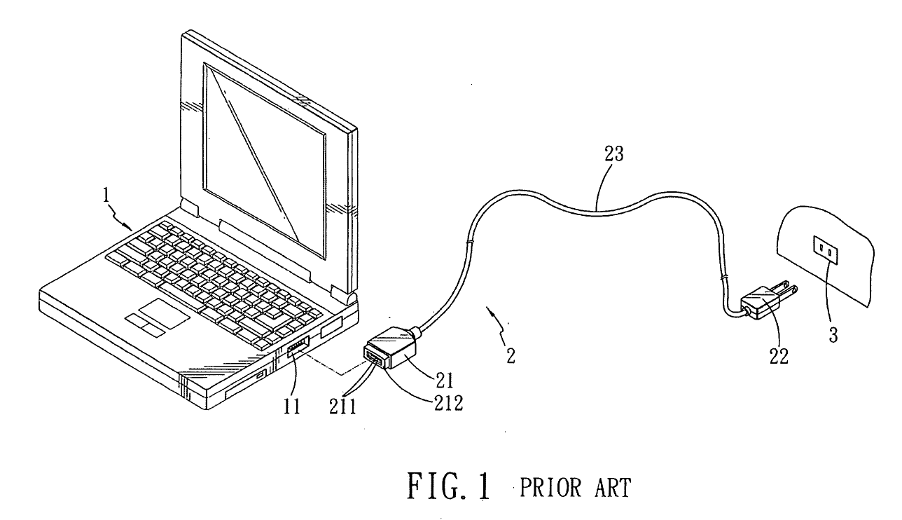

### DETAILED DESCRIPTION OF THE PREFERRED EMBODIMENT

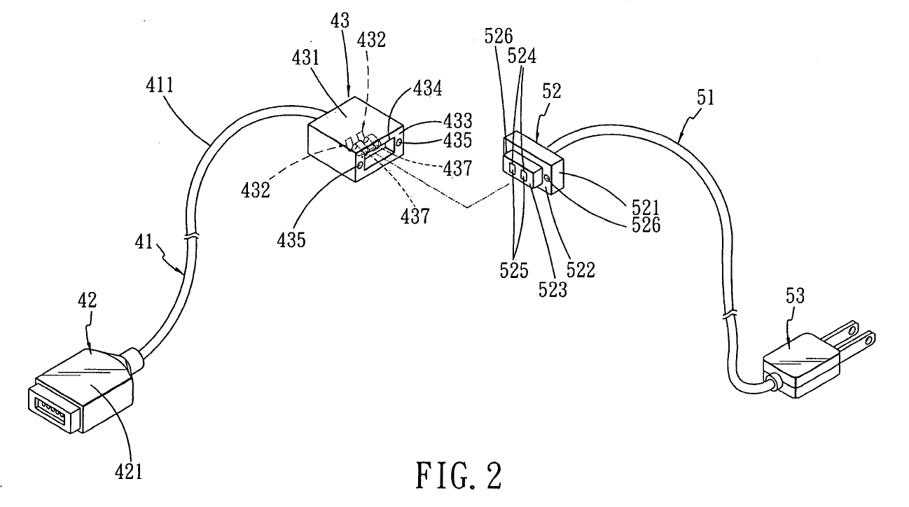

Referring to FIGS. 2 to 5, the preferred embodiment of a power cord assembly according to the present invention includes first and second cable units 4, 5, and a power supply unit 63. The first cable unit 4 includes the following: a first cable 41 having first and second ends, and an insulation sheath 411; a device connector 42 disposed on the first end of the first cable 41 in a connector housing 421 and adapted to be electrically coupled to a power port 612 of an electrical device 61 (e.g., a laptop computer or a kitchen appliance) and a first connector 43 disposed on the second end of the first cable 41. The second cable unit 5 includes the following: a second cable 51 having first and second ends; a power plug 53 disposed on the first end of the second cable 51, and which is adapted to be coupled to a power outlet 62 and is in the form of a male plug; and a second connector 52 disposed on the second end of the second cable 51. The first and second connectors 43, 52 are coupled electrically, magnetically, and releasably to each other. The power supply unit 63 is disposed on one of the first cable 41 and the second cable 51. The power supply unit 63 is adapted to convert a voltage supplied through the power plug 53 from the power outlet 62 to a different voltage.

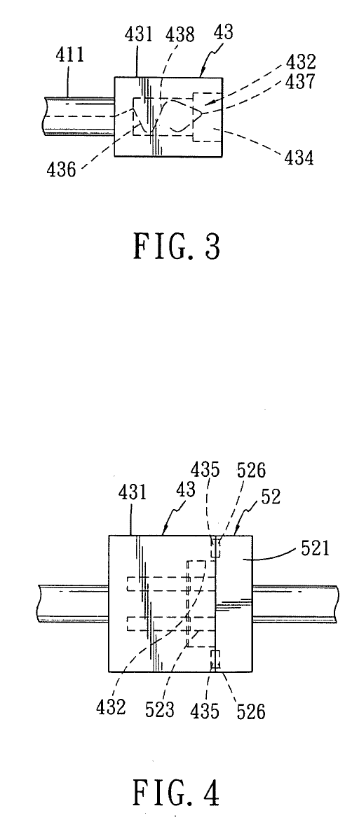

Referring to FIGS. 2 and 3, the first connector 43 includes a first housing 431 having a first contact surface 433 and which is formed with a cavity 434 extending inwardly from the first contact surface 433, and a plurality of first contacts 432 disposed in the cavity 434 and electrically coupled to the first cable 41. Each of the first contacts 432 is approximately S-shaped and has opposite rear and front portions 436, 437, and a middle portion 438 that interconnects the rear and front portions 436, 437. The front portion 437 of each of the first contacts 432 protrudes outwardly into the cavity 434.

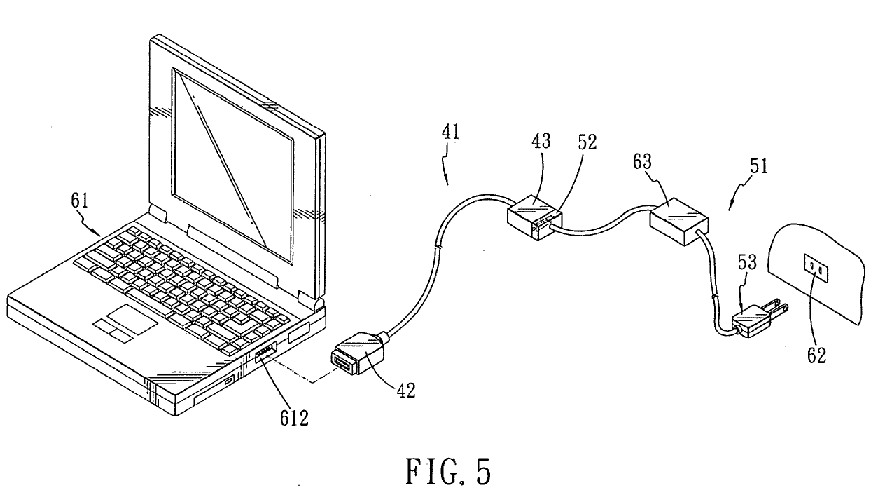

Reference is now made to FIGS. 2 and 5. The second connector 52 includes a second housing 521 having a second contact surface 522, a protrusion 523 extending outwardly from the second contact surface 522 and which is formed with a plurality of holes 524, and a plurality of second contacts 525 disposed respectively in the holes 524 and electrically coupled to the second cable 51.

In this embodiment, a magnet 526 is disposed on one of the first contact surface 433 and the second contact surface 522, and a metal plate 435 is disposed on the other of the first contact surface 433 and the second contact surface 522. The magnet 526 and the metal plate 435 are magnetically attracted to each other when the first and second connectors 43, 52 are coupled to each other so that the protrusion 523 is held in place inserted into the cavity 434, and the front portion 437 of each of the first contacts 432 is held in place inserted in a respective one of the holes 524 and contacting the second contacts 525.

In view of above, the present invention overcomes the abovesaid prior art drawback of damage to the electrical device 61 caused by high temperatures. That is, by providing the magnetic coupling between the first and second connectors 43, 52, which are distanced from the electrical device 61, rather than directly with the electrical device 61, damage to the electrical device 61 in the event that high temperatures are generated in the first and second connectors 43, 52 is avoided.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A power cord assembly comprising:
a first cable unit including a first cable having first and second ends, a device connector disposed on said first end of said first cable and adapted to be coupled to a power port of an electrical device, and a first connector disposed on said second end of said first cable; and
a second cable unit including a second cable having first and second ends, a power plug disposed on said first end of said second cable and adapted to be coupled to a power outlet, and a second connector disposed on said second end of said second cable;
wherein said first and second connectors are coupled electrically, magnetically, and releasably to each other.

2. The power cord assembly as claimed in claim 1, further comprising a power supply unit disposed on one of said first cable and said second cable, said power supply unit being adapted to convert a voltage supplied through said power plug from the power outlet to a different voltage.

3. The power cord assembly as claimed in claim 1, wherein:
said first connector includes a first housing having a first contact surface and which is formed with a cavity extending inwardly from said first contact surface, and a plurality of first contacts disposed in said cavity and electrically coupled to said first cable;
said second connector includes a second housing having a second contact surface, a protrusion extending outwardly from said second contact surface and which is formed with a plurality of holes, and a plurality of second contacts disposed respectively in said holes and electrically coupled to said second cable; and
when said first and second connectors are coupled to each other, said first and second contact surfaces are magnetically attracted to each other, said protrusion is inserted into said cavity, and said first contacts are inserted respectively into said holes to contact said second contacts.

4. The power cord assembly as claimed in claim 3, further comprising a magnet disposed on one of said first contact surface and said second contact surface, and a metal plate disposed on the other of said first contact surface and said second contact surface, said magnet and said metal plate being magnetically attracted to each other when said first and second connectors are coupled to each other.
